(19) United States
(12) Patent Application Publication
(10) Pub. No.: US 2026/0220623 A1
(43) Pub. Date: Jul. 30, 2026

(54) TWO-SPEED TRANSACTIONS ARCHITECTURE AND SYSTEM

(71) Applicant: Wells Fargo Bank, N.A., San Francisco, CA (US)

(72) Inventor: Peter Rozovski, Concord, CA (US)

(21) Appl. No.: 19/038,370

(22) Filed: Jan. 27, 2025

(51) Int. Cl. G06Q 20/10; G06Q 20/42

(52) U.S. Cl. CPC G06Q 20/102; G06Q 20/42

(57) ABSTRACT

Systems and techniques may generally be used for facilitating real-time or next-day transactions (e.g., for bill pay). An example technique may include presenting, to a bill pay customer, a user interface including a set of mutually exclusive selectable indications, the set of mutually exclusive selectable indications including a first selectable indication representing a real-time payment option and a second indication representing a next-day payment option, receiving a selection of the first selectable indication representing the real-time payment option, and attempting to send a real-time payment to the bill payee from an account of the bill pay customer. The example technique may include receiving an indication that the real-time payment failed, and reattempting the real-time payment to the bill payee from the account of the bill pay customer.

### BACKGROUND

Transactions ((payment) systems often face challenges in providing efficient and reliable processing options for payments. Traditional methods may involve delays, lack of immediate processing and limited flexibility. New real-time transaction systems like Real-Time Payments via TCH (RTP TCH), FedNow Instant Payments, Zelle via Early Warning System (EWS), suffer from inconsistency, they are unreliable leading to payment failures, face problems to prevent fraud attacks, have serious transaction amounts limitations. All such issues may result in customer dissatisfaction or operational inefficiencies for traditional next-day transaction systems and modern real-time transaction systems.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system diagram for facilitating two-speed transactions in accordance with some examples.

FIG. 2 illustrates a swim lane diagram for two-speed transactions in accordance with some examples.

FIGS. 3A-3E illustrate user interfaces for facilitating two-speed transactions in accordance with some examples.

FIG. 4 illustrates a flowchart showing a technique for facilitating two-speed transactions in accordance with some examples.

FIG. 5 illustrates generally an example of a block diagram of a machine upon which any one or more of the techniques discussed herein may perform in accordance with some examples.

### DETAILED DESCRIPTION

The systems and techniques described herein may be used for real-time and next-day bill pay. An architecture may be used to facilitate a real-time bill payment while providing a mechanism for switching to a next-day bill payment, such as when the real-time bill payment fails. Payment systems have trade offs between speed of payment and cost of payment. Speed of payments typically can range from next day payments to real-time payments. However, most payment systems use only one payments speed. Legacy systems, such as automated clearing house (ACH) payments are typically next-day payments. Newer payment systems such as Zelle are typically real-time or near-real-time payments. Table 1 below shows some advantages and some disadvantages of various payment speeds.

TABLE 1

| Payments | | |
|---|---|---|
| Model | Advantages | Disadvantages |
| Regular | Extremely reliable and | Slow |
| Speed | supportable | |
| Payments | Supported for all FIs (all | |
| | routing numbers) | |
| | Extremely Mature | |
| | Have advanced fraud | |
| | defense | |
| | Support both current date | |
| | and future date payments | |
| | Have fewer payment | |
| | amount limits compare to | |
| | real-time payments | |
| Real-Time | Fast | Not reliable - any production |
| Payments | | issue in chain of vendors and |
| | | billers - stops all or given biller |
| | | Supported only partial list of FIs |
| | | (for small businesses - 60-70% of |
| | | RTNs) |
| | | Not Mature - some solutions like |
| | | FedNow Instant Payments are |
| | | still not finalized, not widely |
| | | supported by industry and are still |
| | | questionable |
| | | Have problems to prevent fraud |
| | | due to very short window of time |
| | | to complete |
| | | Can be applied only to current |
| | | date payments |
| | | Have more payment amount |
| | | limits than next-day payments |

As indicated above in Table 1, a payment system that relies only on one payment speed has issues. The systems and techniques described herein provide a payment system for to support payments that are same-day or next-day, including supporting real-time payments. These systems and techniques provide the advantages of regular payments (e.g., high reliability, high supportability, support for all destination (PAY-TO) financial institutions, maturity, etc.) while also supporting real-time payments when preferred.

In an example, a real-time payment is used when available, and when an issue arises in the real-time payment, embedded re-try logic may be used to re-try attempts to process payment later using real-time rail. The switch to a non-real-time payment may occur after a number of retries (e.g., zero, one, two, five, etc.) or when a cut-off time for making a next day payment is reached (e.g., an end of day time, such as 4 μm, 5 μm, etc.).

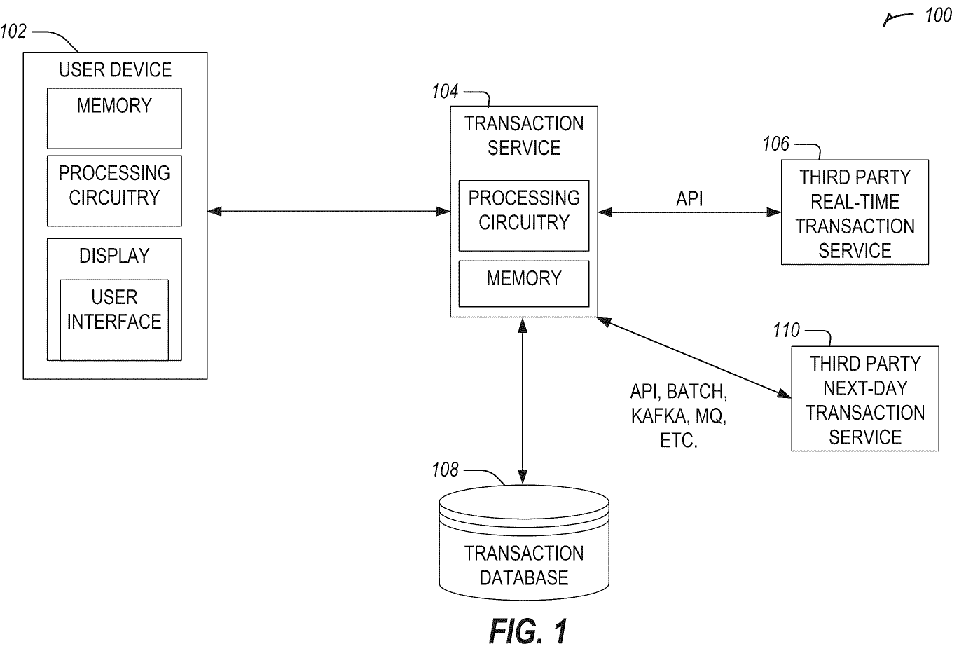

FIG. 1 illustrates a system diagram 100 for facilitating two-speed transactions in accordance with some examples. The system diagram 100 includes a user device 102, a transaction service 104, a third party real-time transaction service 106, a third party next-day transaction service 110 and a transaction database 108. In some examples, the transaction database 108 and the transaction service 104 may be operated using a server, a set of servers, etc.

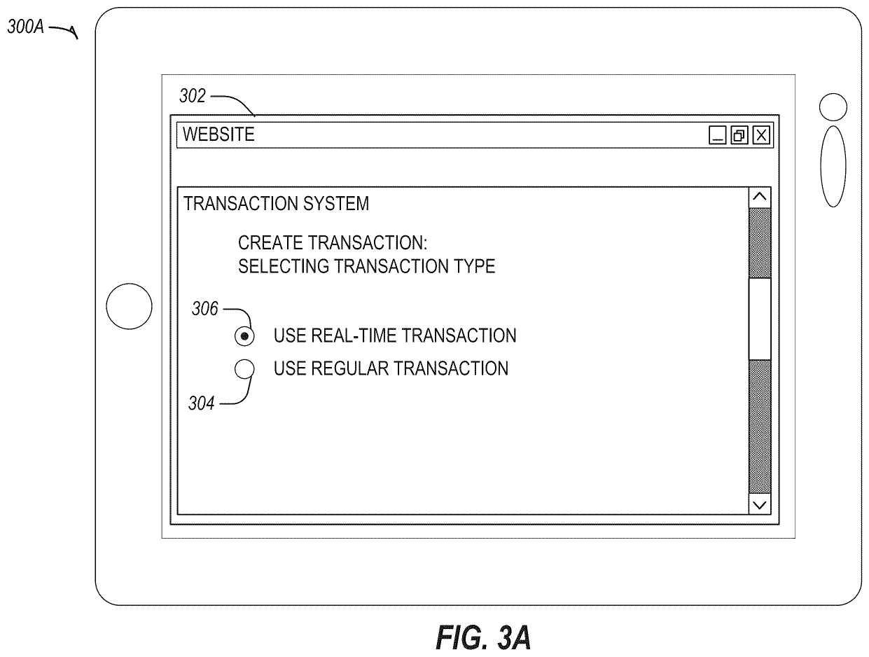

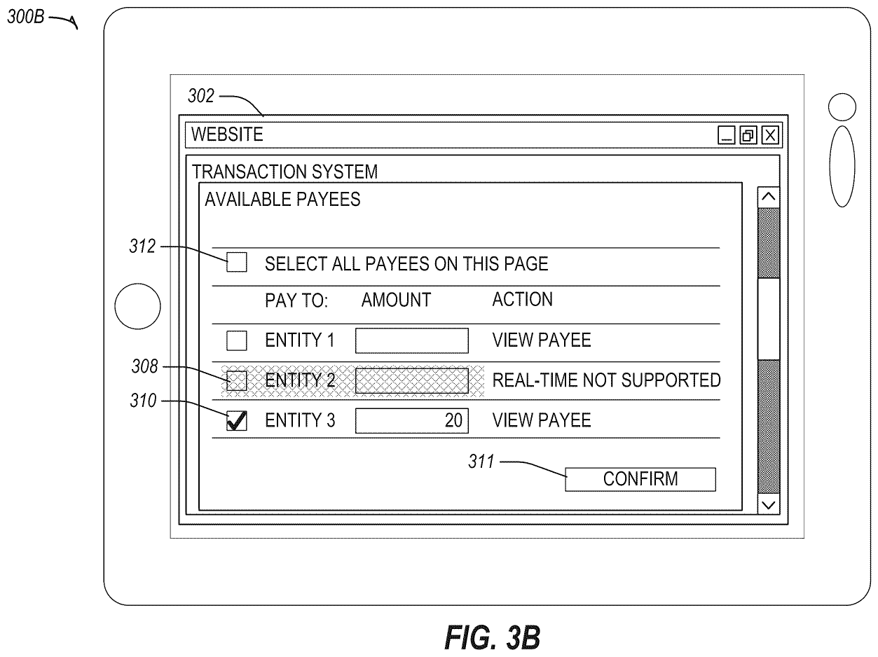

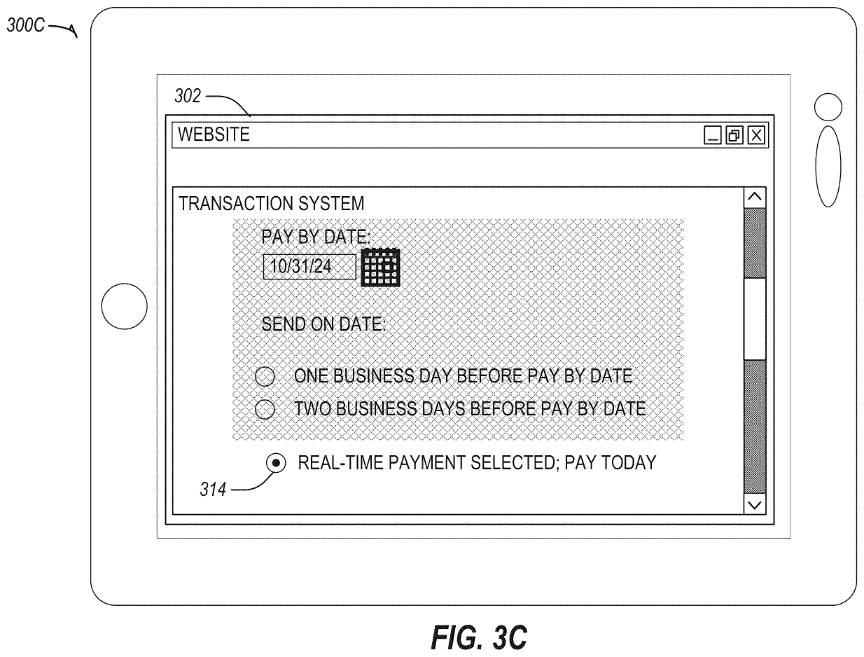

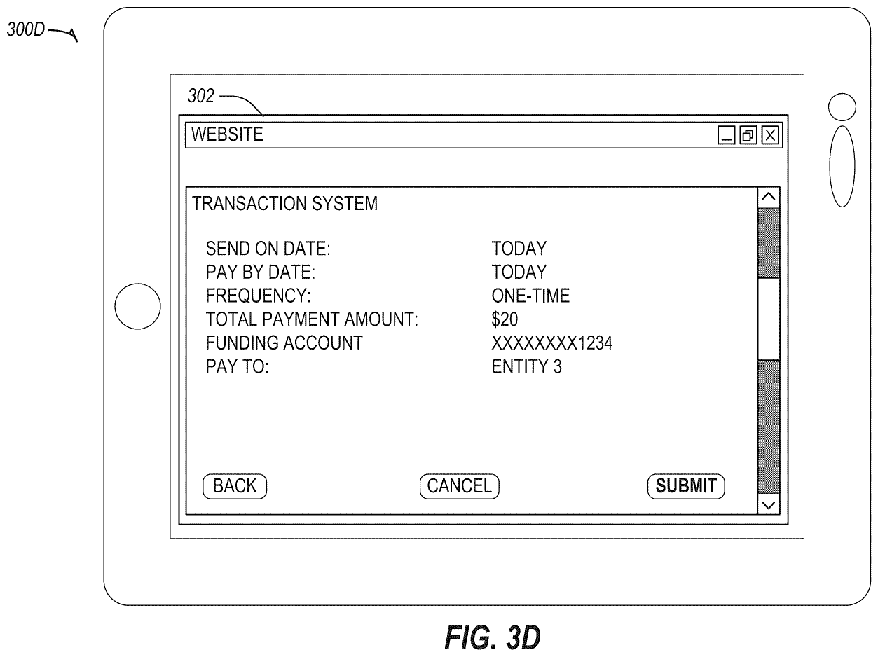

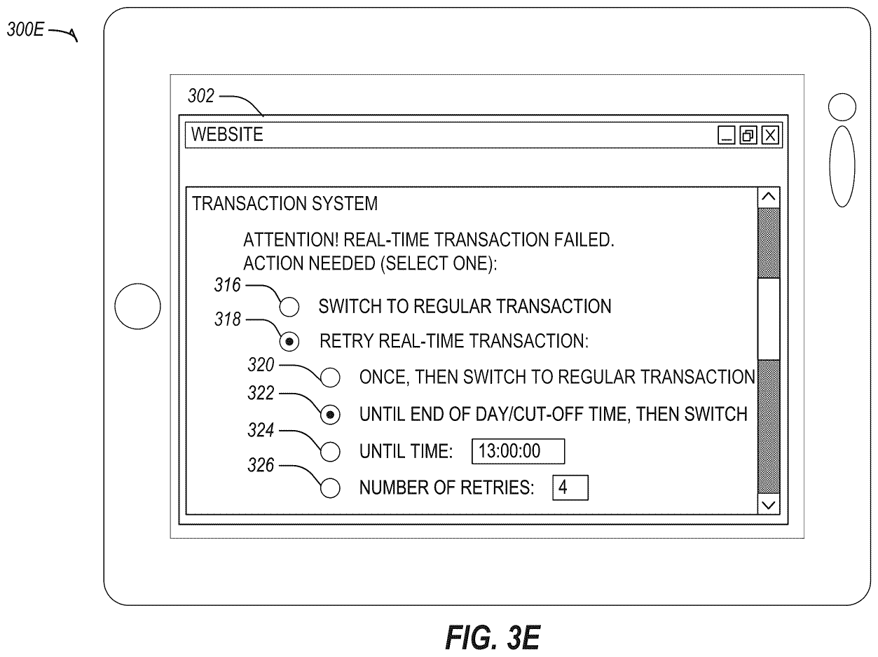

The user device 102 includes memory, processing circuitry, and a display to show a user interface, for example to select a bill pay setting, parameter, or option. The user device 102 may present a web interface on the display, for example as sent from the transaction service 104. The web interface may display one or more options for paying a bill. The web interface is discussed further below with respect to FIGS. 3A-3E. The transaction service 104 includes processing circuitry and memory to generate the web interface, retrieve or send data from or to the transaction database 108, or to communicate with the third party real-time transaction service 106, for example via an application programming interface (API). The transaction service 104 may communicate with the third party next-day transaction service 110, for example via an API, batch, Kafka, MQ, etc.

The user device 102 may be used to generate, modify, confirm, etc. bill payments, such as for payroll (e.g., to employees), vendor payments, recurring payments, debt payments, or the like. The user device 102 may be associated with a business, such as a small business. The transaction service 104 may be implemented at a server, such as a bank server.

A customer may create one or more payee accounts (e.g., a “pay to” account) at the user device 102. A payee account may include a routing number and an account number when RTP TCH or Fed Now Instant payments processors are used, or Zelle token (cell phone number of e-mail address) when Zelle real-time payments are used. A payee account can have an additional optional parameter such as a label (e.g., a name). A payment may be sent by the transaction service 104 on demand or repeatedly (e.g., daily) to the third-party real-time or next-day transaction services 106 or 110. The third-party transaction services 106 or 110 process payments, received from the transaction service 104 (e.g., where the payee account has an account at the operator bank of the transaction service 104). In examples where the payee account is not at the operator bank of the transaction service 104, the transaction service 104 may send the payment (e.g., using the third party real-time transaction service 106) to third-party transaction service 106 or 110 (e.g., The Clearing House (TCH), Real-Time Payment via The Clearing House (RTP TCH), FedNow Instant Payments, Zelle, Plaid, FISERV, FIS GLOBAL, VISA, MASTER CARD. or some other payment processor) for processing. The transaction service 104 may receive a response (e.g., a file or combination of files) with an indication of whether the payment was confirmed, rejected, or returned. In an example of ON-US payment where a payment is sent from a first bank account of a bank to a second bank account of the bank, the transaction service 104 (e.g., when operated by the bank) may send payment to an internal bank system instead of third-party transaction services 106 or 110 to process the payment.

In an example, the transaction service 104 may configure payment information to be the same regardless of whether a payment speed is selected as real-time or next-day (or otherwise). For example, a payment may be configured to include a routing number and an account number to be sent to a payment destination, in either case where the payment destination is a real-time payment or a next-day payment. In some examples, the user device 102 may be queried by the transaction service 104 to obtain pre-authorization for switching between real-time and next-day payments, for example for compliance requirements.

The transaction service 104 may implement one or more batch jobs to execute next-day payments or re-try attempts for real-time payments. For example, a batch job may run every N minutes to scan delayed payments in queue and reattempt the payments. A second batch job may run at a cut-off time to converts all non-delivered delayed payments from real-time payments to regular speed payments (e.g., next-day payments).

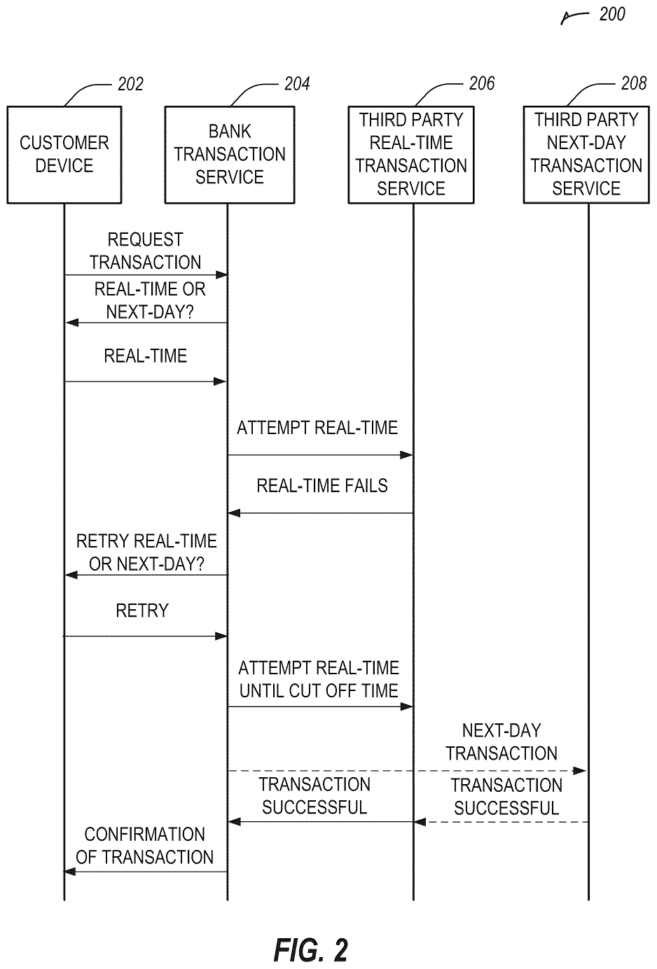

FIG. 2 illustrates a swim lane diagram 200 for two-speed transactions in accordance with some examples. In the swim lane diagram 200, a customer device 202 interacts with a bank transaction service 204. The bank transaction service 204 may interact with a third party real-time transaction service 206 or a next-day transaction service 208. The customer device 202 may request a transaction to be made by the bank transaction service 204. The bank transaction service 204 may send a response asking whether the transaction is to be a real-time transaction or a next-day transaction. The customer device 202 may send a response that the transaction is a real-time transaction. In some examples, instead of having the bank transaction service 204 send the response, the initial request from the customer device 202 may indicate whether the transaction is a real-time transaction request or a next-day transaction request.

The bank transaction service 204 may attempt a real-time transaction with the third party real-time transaction service 206. The third party real-time transaction service 206 may send a response that the real-time transaction has failed, or the bank transaction service 204 may determine that the real-time transaction has failed based on expiration of a timer (e.g., a time-out event), an indication from an intermediary device or service (e.g., an API), or the like. The bank transaction service 204 may send an update to the customer device 202 asking if the customer would like to retry the real-time transaction or switch to a next-day transaction. In response to receiving an indication to retry the real-time transaction from the customer device 202, the bank transaction service 204 may attempt the real-time transaction once, repeatedly, or until a cut off time (e.g., an end of day cut of time) with the third party real-time transaction service 206. When the cut off time, repeat number, or single attempt are reached and no payment has been completed, the bank transaction service 204 may initiate a next-day transaction via the third party next-day transaction service 208. When a repeated attempt real-time transaction is successful or the next-day transaction is successful, the third party real-time transaction service 206 or the third party next-day transaction service 208 may send an indication that the transaction was successful. The bank transaction service 204 may send a confirmation of the successful transaction to the customer device 202.

FIGS. 3A-3E illustrate user interfaces for facilitating two-speed transactions in accordance with some examples.

FIG. 3A illustrates a first view 300A of a website 302 on a user device. The website 302 may be used to complete a transaction by a user. The website 302 provides an opportunity for a user to create a transaction, such as a payment, for example by selecting a transaction type. The transaction type may include a real-time transaction 306 or a regular transaction 304 (e.g., a next-day transaction, an ACH transaction, etc.). In some examples, the real-time transaction 306 rail may be used only for a one-time transaction for a current day. Real-time transactions may have lower transaction limits compared to regular transactions, in some examples. When the user selects an indication (e.g., a radio-button in FIG. 3A) for the real-time transaction 306, the website 302 may change to a second view 300B in FIG. 3B. In some examples, when the user selects that the transaction type is recurring, a radio button corresponding to the regular transaction 304 selection may be activated and the radio-button corresponding to the real-time transaction 306 may not be selectable. (e.g., grayed-out or not active).

FIG. 3B illustrates the second view 300B of the website 302 on the user device. The website in the second view 300B includes options to select a payee from available payees. The website 302 may provide an option to enter a new payee. In the example shown in the second view 300B, the website 302 displays three entities, where entity 2 is not selectable 308 because entity 2 (or a bank of entity 2) does not support real-time transactions. The user has selected 310 entity 3, and entered an amount “20.” The website 302 may include an option to select 312 all available payees on the page. A confirmation button 311 to continue to a next page may be displayed on the website 302.

FIG. 3C illustrates a third view 300C of the website 302 on the user device. The third view 300C may be displayed in response to the user selecting confirm 311. The third view 300C illustrates that selections for future transaction dates or times are not available because a real-time transaction rail was previously selected (e.g., on the first view 300A). A radio button 314 corresponding to the real-time transaction selection may be automatically selected, and a payment may be indicated to be made on a current day. In examples where a real-time transaction was not selected, the send on date selections may be available and the radio button 314 corresponding to the real-time transaction selection may instead be unavailable. In some examples, only details of the website 302 related to a current selection may be displayed or this page may be omitted when real-time transaction is selected.

FIG. 3D illustrates a fourth view 300D of the website 302 on the user device. The fourth view 300D may be presented on the website 302 to show a user details (e.g., for confirmation by the user). The user may change an option by selecting a back button, cancel the transaction by selecting a cancel button, or submit the transaction with the current options by selecting a submit button. After the user selects the submit button, the website 302 may send payment details to either a regular payment rail or a real-time payment rail.

FIG. 3E illustrates a fifth view 300E of the website 302 on the user device. The fifth view 300 illustrates an example where a real-time transaction was selected but then failed. The website 302 in this example shows various options for what the user may do in response to the failure of the real-time transaction. The user may select a radio button 316 to switch to a regular transaction or select a radio button 318 to retry at least one real-time transaction. In some examples, when the radio button 316 is selected, the remaining real-time options may be disabled.

When the user selects the radio button 318, further options may be provided (e.g., selectable or displayed). The further options may include parameters for retrying the real-time transaction. The real-time transaction may be retried once, then switched to a regular transaction by selection of radio button 320. The real-time transaction may be retried until an end of day or cut-off time and then switched to a regular transaction by selection of radio button 322. The real-time transaction may be retried until a specific time (e.g., 1 μm in the example shown in the fifth view 300E) then switched to a regular transaction by selection of radio button 324. The real-time transaction may be retried a number of times (e.g., 4 in the example shown in the fifth view 300E) then switched to a regular transaction by selection of radio button 326. Selection of radio button 324 or 326 may include an option to enter a time or number of retries, respectively. In other examples, the time or number of retries may be set automatically (e.g., by an administrator of the website 302), or be selectable from among a number of options. In some examples, the website 302 may present an option to cancel the transaction in response to the real-time transaction failure.

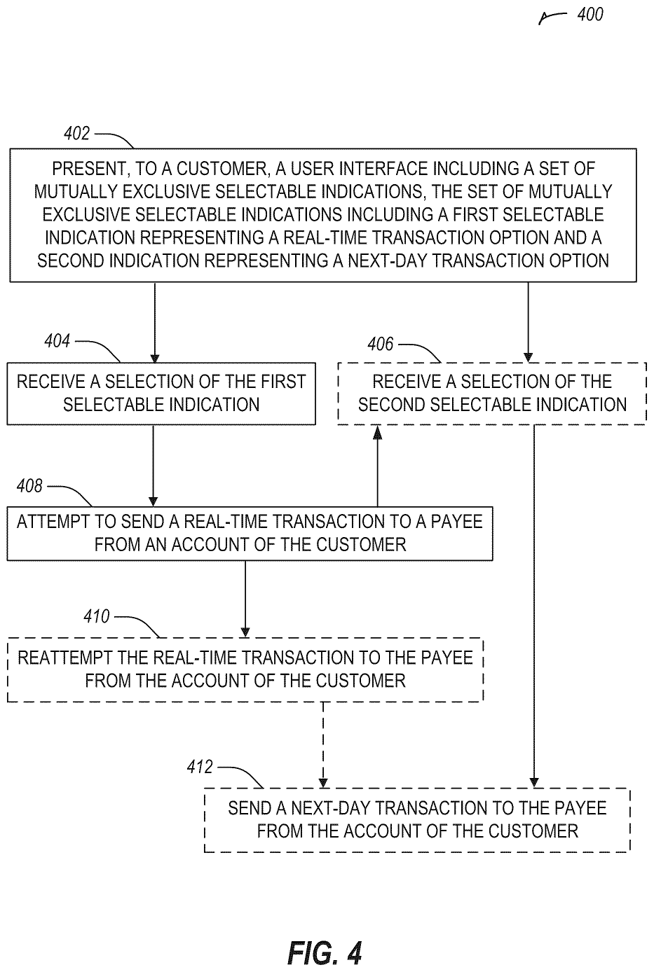

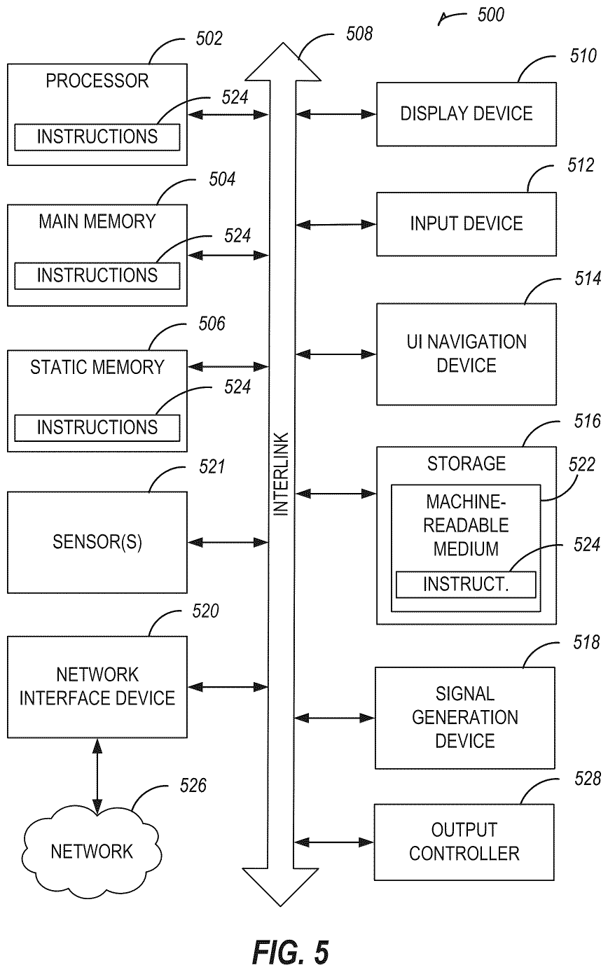

FIG. 4 illustrates a flowchart showing a technique 500 for facilitating two-speed transactions in accordance with some examples. In an example, operations of the technique 400 may be performed by processing circuitry, for example by executing instructions stored in memory. The processing circuitry may include a processor, a system on a chip, or other circuitry (e.g., wiring). For example, the technique 400 may be performed by processing circuitry of a device (or one or more hardware or software components thereof), such as those illustrated and described with reference to FIG. 5.

The technique 400 includes an operation 402 to present, to a customer, a user interface including a set of mutually exclusive selectable indications, the set of mutually exclusive selectable indications including a first selectable indication representing a real-time transaction option and a second indication representing a next-day transaction option. In an example, operation 402 includes presenting a second set of mutually exclusive selectable indications, the second set of mutually exclusive selectable indications including a third selectable indication representing a one-time transaction option and a fourth selectable indication representing a recurring transaction option. In this example, operation 402 may include receiving a selection of the fourth selectable indication and in response to receiving a second indication that reattempting the real-time transaction failed, converting a future recurring transaction for the customer to the payee to a next-day transaction.

The technique 400 includes an operation 404 to receive a selection of the first selectable indication. Operation 404 may include displaying, on the user interface, a list of payees that are configured to accept real-time transactions from the customer. The customer may select a payee from the list of payees.

The technique 400 includes an optional operation 406 to receive a selection of the second selectable indication. In some examples, the second selectable indication may be selected instead of the first selectable indication. In these examples, the technique 400 proceeds to optional operation 412 to send a next-day transaction. In other examples, after the first selectable indication is selected, the second selectable indication may be selected (e.g., after operation 408 fails, after operation 410 fails, such as at a cut-off time, or the like).

The technique 400 includes an operation 408 to attempt to send a real-time transaction to the payee from an account of the customer. Operation 408 may include receiving an indication that the real-time transaction failed. Operation 408 may include requesting, via the user interface, whether the real-time transaction is to be reattempted or is to be switched to a next-day transaction. When the bill pay customer selects switching to the next-day transaction (e.g., optional operation 406), the technique 400 may proceed to optional operation 412 to send the next-day transaction. When the customer selects to reattempt, operation 408 may include receiving a response to the request to reattempt the real-time transaction. The request to reattempt may include a number of times to reattempt (e.g., once, three times, etc.), a time limit (e.g., try until 1 μm Eastern time), no limit (e.g., reattempt until the cut-off time at the end of the day), or the like. When reattempting is requested, the technique 400 proceeds to an optional operation 410.

Optional operation 410 includes reattempting the real-time transaction to the payee from the account of the customer. When optional operation 410 is successful, the technique 400 may include sending a real-time transaction confirmation to the customer. When optional operation 410 fails (e.g., is unsuccessful), optional operation 410 may be repeated one or more times (e.g., according to a specified number of times, time limit, or cut-off time) or may proceed to optional operation 412 (e.g., where only one reattempt was requested). When repeating optional operation 410, a cut-off time may be set (e.g., by a financial institution) for switching to a next-day transaction. The cut-off time may include an end of financial day (e.g., 3 μm Eastern time). When the cut-off time or other time or number limit is reached, the technique 400 proceeds to optional operation 412.

The technique 400 includes an optional operation 412 to send a next-day transaction to the payee from the account of the customer. In an example, the real-time payment is a wire transfer. In an example, the next-day transaction includes clearing a payment through an automated clearing house.

The technique 400 may include an operation including, after reattempting the real-time transaction to the payee, switching the real-time transaction to the next-day transaction and queuing the next-day transaction for processing. The technique 400 may include an operation including, after reattempting the real-time transaction to the payee, receiving a second indication that reattempting the real-time transaction failed, and in response, waiting a period of time before reattempting the real-time transaction again. The technique 400 may include an operation including, before attempting to send the real-time transaction, prompting the customer for confirmation to submit the real-time transaction to the payee, and receiving the confirmation. The technique 400 may include an operation including, in response to receiving the indication that the real-time transaction failed, removing the payee from the list of payees that are configured to accept real-time transaction for a specified period of time.

FIG. 5 illustrates generally an example of a block diagram of a machine 500 upon which any one or more of the techniques (e.g., methodologies) discussed herein may perform in accordance with some examples. In alternative examples, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: presenting, to a bill pay customer, a user interface including a set of mutually exclusive selectable indications, the set of mutually exclusive selectable indications including a first selectable indication representing a real-time payment option and a second indication representing a next-day payment option; receiving a selection of the first selectable indication representing the real-time payment option; displaying, on the user interface, a list of bill payees that are configured to accept real-time payments from the bill pay customer; receiving a selection of a bill payee from the list of bill payees; attempting to send a real-time payment to the bill payee from an account of the bill pay customer; receiving an indication that the real-time payment failed; requesting, via the user interface, whether the real-time payment is to be reattempted or is to be switched to a next-day payment; receiving a response to the request to reattempt the real-time payment; and reattempting the real-time payment to the bill payee from the account of the bill pay customer.

In Example 2, the subject matter of Example 1 includes, after reattempting the real-time payment to the bill payee, switching the real-time payment to the next-day payment and queuing the next-day payment for processing.

In Example 3, the subject matter of Examples 1-2 includes, after reattempting the real-time payment to the bill payee, receiving a second indication that reattempting the real-time payment failed, and in response, waiting a period of time before reattempting the real-time payment again.

In Example 4, the subject matter of Examples 1-3 includes, before attempting to send the real-time payment, prompting the bill pay customer for confirmation to submit the real-time payment to the bill payee, and receiving the confirmation.

In Example 5, the subject matter of Examples 1~4 includes, in response to receiving the indication that the real-time payment failed, removing the bill payee from the list of bill payees that are configured to accept real-time payments for a specified period of time.

In Example 6, the subject matter of Examples 1-5 includes, wherein presenting the user interface includes presenting a second set of mutually exclusive selectable indications, the second set of mutually exclusive selectable indications including a third selectable indication representing a one-time payment option and a fourth selectable indication representing a recurring payment option.

In Example 7, the subject matter of Example 6 includes, receiving a selection of the fourth selectable indication and in response to receiving a second indication that reattempting the real-time payment failed, converting a future recurring payment for the bill pay customer to the bill payee to a next-day payment.

In Example 8, the subject matter of Examples 1-7 includes, wherein the real-time payment is a wire transfer and the next-day payment includes clearing a payment through an automated clearing house.

Example 9 is a system comprising: processing circuitry; and memory, including instructions, which when executed by the processing circuitry cause the processing circuitry to perform operations to: present, to a bill pay customer, a user interface including a set of mutually exclusive selectable indications, the set of mutually exclusive selectable indications including a first selectable indication representing a real-time payment option and a second indication representing a next-day payment option; receive a selection of the first selectable indication representing the real-time payment option; display, on the user interface, a list of bill payees that are configured to accept real-time payments from the bill pay customer; receive a selection of a bill payee from the list of bill payees; attempt to send a real-time payment to the bill payee from an account of the bill pay customer; receive an indication that the real-time payment failed; request, via the user interface, whether the real-time payment is to be reattempted or is to be switched to a next-day payment; receive a response to the request to switch the real-time payment to a next-day payment; and process the next-day payment to the bill payee from the account of the bill pay customer.

In Example 10, the subject matter of Example 9 includes, wherein the instructions further cause the processing circuitry to, before attempting to send the real-time payment, prompt the bill pay customer for confirmation to submit the real-time payment to the bill payee, and receiving the confirmation.

In Example 11, the subject matter of Examples 9-10 includes, wherein the instructions further cause the processing circuitry to, in response to receiving the indication that the real-time payment failed, remove the bill payee from the list of bill payees that are configured to accept real-time payments for a specified period of time.

In Example 12, the subject matter of Examples 9-11 includes, wherein to present the user interface includes to present a second set of mutually exclusive selectable indications, the second set of mutually exclusive selectable indications including a third selectable indication representing a one-time payment option and a fourth selectable indication representing a recurring payment option.

In Example 13, the subject matter of Example 12 includes, wherein the instructions further cause the processing circuitry to receive a selection of the fourth selectable indication and in response to receiving a second indication that reattempting the real-time payment failed, convert a future recurring payment for the bill pay customer to the bill payee to a next-day payment.

In Example 14, the subject matter of Examples 9-13 includes, wherein the real-time payment is a wire transfer and the next-day payment includes clearing a payment through an automated clearing house.

Example 15 is at least one non-transitory machine-readable medium including instructions, which when executed by processing circuitry, causes the processing circuitry to perform operations to: present, to a bill pay customer, a user interface including a set of mutually exclusive selectable indications, the set of mutually exclusive selectable indications including a first selectable indication representing a real-time payment option and a second indication representing a next-day payment option; receive a selection of the first selectable indication representing the real-time payment option; display, on the user interface, a list of bill payees that are configured to accept real-time payments from the bill pay customer; receive a selection of a bill payee from the list of bill payees; request, via the user interface, whether a real-time payment is to be reattempted or is to be switched to a next-day payment; receive a response to the request to reattempt the real-time payment; attempt to send the real-time payment to the bill payee from an account of the bill pay customer; receive an indication that the real-time payment failed; and reattempt the real-time payment to the bill payee from the account of the bill pay customer.

In Example 16, the subject matter of Example 15 includes, wherein the instructions further cause the processing circuitry to, after reattempting the real-time payment to the bill payee, switch the real-time payment to the next-day payment and queuing the next-day payment for processing.

In Example 17, the subject matter of Examples 15-16 includes, wherein the instructions further cause the processing circuitry to, after reattempting the real-time payment to the bill payee, receive a second indication that reattempting the real-time payment failed, and in response, waiting a period of time before reattempting the real-time payment again.

In Example 18, the subject matter of Examples 15-17 includes, wherein the instructions further cause the processing circuitry to, before attempting to send the real-time payment, prompt the bill pay customer for confirmation to submit the real-time payment to the bill payee, and receiving the confirmation.

In Example 19, the subject matter of Examples 15-18 includes, wherein the instructions further cause the processing circuitry to, in response to receiving the indication that the real-time payment failed, remove the bill payee from the list of bill payees that are configured to accept real-time payments for a specified period of time.

In Example 20, the subject matter of Examples 15-19 includes, wherein the real-time payment is a wire transfer and the next-day payment includes clearing a payment through an automated clearing house.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
presenting, to a customer, a user interface including a set of mutually exclusive selectable indications, the set of mutually exclusive selectable indications including a first selectable indication representing a real-time transaction option and a second indication representing a next-day transaction option;
receiving a selection of the first selectable indication representing the real-time transaction option;
displaying, on the user interface, a list of payees that are configured to accept real-time transactions from the customer, wherein at least one entity is displayed as not selectable based on the at least one entity not supporting real-time transactions or a financial institution associated with the at least one entity not supporting real-time transactions;
receiving a selection of a payee from the list of payees;
attempting to send a real-time transaction to the payee from an account of the customer;
receiving an indication that the real-time transaction failed;
requesting, via the user interface, whether the real-time transaction is to be reattempted or is to be switched to a next-day transaction;
receiving a response to the request to reattempt the real-time transaction; and
reattempting the real-time transaction to the payee from the account of the customer.

2. The method of claim 1, further comprising, after reattempting the real-time transaction to the payee, switching the real-time transaction to the next-day transaction and queuing the next-day transaction for processing.

3. The method of claim 1, further comprising, after reattempting the real-time transaction to the payee, receiving a second indication that reattempting the real-time transaction failed, and in response, waiting a period of time before reattempting the real-time transaction again.

4. The method of claim 1, further comprising, before attempting to send the real-time transaction, prompting the customer for confirmation to submit the real-time transaction to the payee, and receiving the confirmation.

5. The method of claim 1, further comprising, in response to receiving the indication that the real-time transaction failed, removing bill payee from the list of payees that are configured to accept real-time transactions for a specified period of time.

6. The method of claim 1, wherein presenting the user interface includes presenting a second set of mutually exclusive selectable indications, the second set of mutually exclusive selectable indications including a third selectable indication representing a one-time transaction option and a fourth selectable indication representing a recurring transaction option.

7. The method of claim 6, further comprising, receiving a selection of the fourth selectable indication and in response to receiving a second indication that reattempting the real-time transaction failed, converting a future recurring transaction for the customer to the payee to a next-day transaction.

8. The method of claim 1, wherein the real-time transaction is a wire transfer and the next-day transaction includes clearing a payment through an automated clearing house.

9. A system comprising:
processing circuitry; and
memory, including instructions, which when executed by the processing circuitry cause the processing circuitry to perform operations to:
present, to a customer, a user interface including a set of mutually exclusive selectable indications, the set of mutually exclusive selectable indications including a first selectable indication representing a real-time transaction option and a second indication representing a next-day transaction option;
receive a selection of the first selectable indication representing the real-time transaction option;
display, on the user interface, a list of payees that are configured to accept real-time transaction from the customer, wherein at least one entity is displayed as not selectable based on the at least one entity not supporting real-time transactions or a financial institution associated with the at least one entity not supporting real-time transactions;
receive a selection of a payee from the list of payees;
attempt to send a real-time transaction to the payee from an account of the customer;
receive an indication that the real-time transaction failed;
request, via the user interface, whether the real-time transaction is to be reattempted or is to be switched to a next-day transaction;
receive a response to the request to switch the real-time transaction to a next-day transaction; and
process the next-day transaction to the payee from the account of the customer.

10. The system of claim 9, wherein the instructions further cause the processing circuitry to, before attempting to send the real-time transaction, prompt the customer for confirmation to submit the real-time transaction to the payee, and receiving the confirmation.

11. The system of claim 9, wherein the instructions further cause the processing circuitry to, in response to receiving the indication that the real-time transaction failed, remove the payee from the list of payees that are configured to accept real-time transactions for a specified period of time.

12. The system of claim 9, wherein to present the user interface includes to present a second set of mutually exclusive selectable indications, the second set of mutually exclusive selectable indications including a third selectable indication representing a one-time transaction option and a fourth selectable indication representing a transaction payment option.

13. The system of claim 12, wherein the instructions further cause the processing circuitry to receive a selection of the fourth selectable indication and in response to receiving a second indication that reattempting the real-time transaction failed, convert a future recurring transaction for the customer to the payee to a next-day payment.

14. The system of claim 9, wherein the real-time transaction is a wire transfer and the next-day transaction includes clearing a payment through an automated clearing house.

15. At least one non-transitory machine-readable medium including instructions, which when executed by processing circuitry, causes the processing circuitry to perform operations to:
present, to a customer, a user interface including a set of mutually exclusive selectable indications, the set of mutually exclusive selectable indications including a first selectable indication representing a real-time transaction option and a second indication representing a next-day transaction option;
receive a selection of the first selectable indication representing the real-time transaction option;
display, on the user interface, a list of payees that are configured to accept real-time transactions from the customer, wherein at least one entity is displayed as not selectable based on the at least one entity not supporting real-time transactions or a financial institution associated with the at least one entity not supporting real-time transactions;
receive a selection of a payee from the list of payees;
request, via the user interface, whether a real-time transaction is to be reattempted or is to be switched to a next-day transaction;
receive a response to the request to reattempt the real-time transaction;
attempt to send the real-time transaction to the payee from an account of the customer;
receive an indication that the real-time transaction failed; and
reattempt the real-time transaction to the payee from the account of the customer.

16. The at least one non-transitory machine-readable medium of claim 15, wherein the instructions further cause the processing circuitry to, after reattempting the real-time transaction to the payee, switch the real-time transaction to the next-day transaction and queuing the next-day transaction for processing.

17. The at least one non-transitory machine-readable medium of claim 15, wherein the instructions further cause the processing circuitry to, after reattempting the real-time transaction to the payee, receive a second indication that reattempting the real-time transaction failed, and in response, waiting a period of time before reattempting the real-time transaction again.

18. The at least one non-transitory machine-readable medium of claim 15, wherein the instructions further cause the processing circuitry to, before attempting to send the real-time transaction, prompt the customer for confirmation to submit the real-time transaction to the payee, and receiving the confirmation.

19. The at least one non-transitory machine-readable medium of claim 15, wherein the instructions further cause the processing circuitry to, in response to receiving the indication that the real-time transaction failed, remove the payee from the list of payees that are configured to accept real-time transactions for a specified period of time.

20. The at least one non-transitory machine-readable medium of claim 15, wherein the real-time transaction is a wire transfer and the next-day transaction includes clearing a payment through an automated clearing house.
